(19) United States
(12) Patent Application Publication
(10) Pub. No.: US 2007/0111598 A1
(43) Pub. Date: May 17, 2007

(54) Electrical connector assemblies and methods of fabrication

(76) Inventor: James E. Quilici, El Dorado Hills, CA (US)

Correspondence Address: BERKELEY LAW & TECHNOLOGY GROUP, LLP, 1700 NW 167TH PLACE, SUITE 240, BEAVERTON, OR, 97006, US

(21) Appl. No.: 11/274,896

(22) Filed: Nov. 14, 2005

(51) Int. Cl. H01R 13/40

(52) U.S. Cl. 439/595

(57) ABSTRACT

Embodiments of electrical connector assemblies and/or method of formation are disclosed. In one embodiment, an electrical connector assembly comprises a receptacle assembly and a plug assembly, wherein the plug assembly includes one or more wire trays coupled to a shroud, and wherein the receptacle assembly comprises two or more stacked and laminated printed circuit sub-assemblies.

### BACKGROUND

This disclosure is related generally to electrical connector assemblies, such as may be employed in voice and/or data transmission devices and/or systems.

Numerous types of electrical connector assemblies may be utilized in voice and/or data communications. Electrical connector assemblies may comprise plug assemblies and/or receptacle assemblies, for example. In this context, receptacle assemblies may additionally be referred to as jacks or ports. Electrical connector assemblies may be utilized in data transmission devices and/or systems for the transmission of data according to any one or several data transmission protocols. For example, one particular type of plug assembly comprises an RJ-45 connector. RJ-45 connectors may be utilized in various applications, such as to provide connectivity for an Ethernet-compliant device that may be capable of transmitting data in accordance with Ethernet standard IEEE Std. 802.3, for example. However, a continuing need exists for improvements in the field of connector technology. For example, a need exists for developments in the areas of increasing port density, plug assemblies and receptacle assemblies, as well as signal integrity, voltage isolation and filtering techniques.

### BRIEF DESCRIPTION OF THE DRAWINGS

Subject matter is particularly pointed out and distinctly claimed in the concluding portion of the specification. The claimed subject matter, however, both as to organization and method of operation, together with objects, features, and advantages thereof, may best be understood by reference of the following detailed description when read with the accompanying drawings in which:

FIG. 1 is a perspective view of one embodiment of an electrical connector including a plug assembly, and a receptacle assembly.

FIG. 2 is another perspective view of one embodiment of an electrical connector including a plug assembly, and a receptacle assembly.

FIGS. 3a-3d are perspective, front, side and top views of a receptacle assembly in accordance with an embodiment;

FIGS. 4a-4b are perspective views of receptacle sub-assembly components in accordance with an embodiment;

FIGS. 5a-5b are perspective views of receptacle sub-assembly components in accordance with an embodiment;

FIGS. 6a-6d are perspective, front, side and top views of a plug assembly in accordance with an embodiment;

FIG. 7 is an exploded perspective view of a plug assembly in accordance with an embodiment;

FIGS. 8a-8b are perspective views of plug sub-assembly components in accordance with an embodiment;

FIG. 9 is a perspective view of a portion of plug sub-assembly components in accordance with an embodiment;

FIGS. 10a-10b are perspective views of plug sub-assembly components in accordance with an embodiment; and

FIG. 11 illustrates a flow chart of a process for forming one or more portions of one or more of the assemblies disclosed herein.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, well-known methods, procedures, components and/or circuits have not been described in detail so as not to obscure claimed subject matter. Additionally, reference throughout this specification to “one embodiment” or “an embodiment” means that a particular feature, structure, or characteristic described in connection with the embodiment is included in at least one embodiment of claimed subject matter. Thus, the appearances of the phrase “in one embodiment” and/or “an embodiment” in various places throughout this specification are not necessarily all referring to the same embodiment.

One disadvantage of state of the art connector technology concerns the number of receptacles that may be implemented as part of a device, such as a data transmission device. For example, an Ethernet-compliant switch may include 12, 24 or 48 receptacles. The receptacles may additionally be referred to as connector ports or jacks. This limitation on the number of receptacles for a device such as a switch may limit the usefulness of the switch in particular applications and/or may impact the system cost. Additionally, as will be explained in more detail later, state of the art electrical connectors may have limitations with respect to voltage isolation, impedance matching, noise filtering and signal integrity, as a few examples.

“Electrical connectors”, as referred to herein relate to devices or components that may provide electrical connections, such as may be utilized to send and/or receive data according to a data transmission format. For example, electrical connectors may include plug assemblies and receptacle assemblies that may provide a physical connection between devices and/or data transmission media. One particular type of electrical connector may comprise an RJ-45 connector. An RJ-45 connector may be capable of receiving an RJ-45 compliant plug, and may provide an electrical connection between a device and a communication media, and/or between two devices, for example. An RJ-45 connector may be adapted to provide an electrical connection that may be suitable to transmit signals, such as voice and data signals, including Ethernet-compliant data signals. Potential capabilities of an electrical connector include the capability to send and/or receive signals that may be compliant with 10/100 BASE-TX, 1000BASE-T, 10GBASE-T signals, ISDN compliant signals, DSL compliant signals, including xDSL compliant signals, Fibre Channel compliant signals, and/or VolP (Voice over Internet Protocol) compliant signals, as just a few examples. Additionally, transmission devices that may employ electrical connectors, such as RJ-45 connectors, may include switches, NICs (Network Interface Devices), routers, hubs, computing systems including servers and personal computers, and so forth. However, it is worthwhile to note that the claimed subject matter is not limited in this respect.

“Substrates”, as referred to herein may refer generally to one or more types of substrate, including but not limited to plastic type substrates, metal type substrates, and semiconductor type substrates, as a few examples. A substrate in accordance with one or more embodiments may comprise a printed circuit board (PCB), for example, and may be comprised of multiple layers having one or more conductive features formed thereon. In one embodiment, a PCB may comprise one or more layers of non-conductive material interleaved and/or laminated with one or more conductive circuit patterns and/or one or more additional layers, for example. One or more non-conductive layers of material may include, for example, one or more resins such as epoxy resins, polymer resins and/or phenolic resins, fibrous material such as fiberglass, or other materials including glass, plastic, carbon, polyimides, polytetrafluoroethylene (PTFE), ceramic and/or quartz, as just a few examples. These non-conductive layers of material may, when assembled into a substrate, be at least partially interleaved with one or more conductive layers, such as one or more layers of conductive circuit patterns, which may additionally be referred to as traces and/or signal layers, one or more ground plane and/or power plane layers, and/or one or pins and/or pads. In at least one embodiment, a conductive layer comprises a layer at least partially comprised of metal, wherein the metal may be selectively patterned to provide one or more interconnections between one or more components and/or one or more conductive features of the substrate, such as one or more pads and/or connectors, and may be formed on one or more surfaces of one or more substrate layers, such as a top surface, for example. Although the claimed subject matter is not so limited, conductive features may be comprised of one or more types of conductive material, including copper, gold, silver, platinum, tin, aluminum, palladium, nickel, and/or alloys thereof, for example.

“Circuitry” as referred to herein relates to structure for performing one or more logical operations. For example, circuitry may provide one or more output signals based at least in part on one or more input signals. Such circuitry may receive a digital input signal and provide a digital output signal, or may provide one or more analog output signals in response to one or more analog input signals. Such circuitry may be provided, for example, in an application specific integrated circuit (ASIC) and/or a field programmable gate array (FPGA). Also, circuitry may comprise processing circuitry to execute such machine-readable instructions. However, these are merely examples of circuitry and claimed subject matter is not limited in these respects.

Unless specifically stated otherwise, as apparent from the following discussion, it is appreciated that throughout this specification discussions utilizing terms such as “processing,” “computing,” “calculating,” “selecting,” “forming,” “enabling,” “obtaining,” “hosting,” “maintaining,” “representing,” “modifying,” “receiving,” “transmitting,” “coupling,” “determining” and/or the like refer to the actions and/or processes that may be performed by a computing platform, such as a computer or a similar electronic computing device, that manipulates and/or transforms data represented as physical, electronic and/or magnetic quantities and/or other physical quantities within the computing platform's processors, memories, registers, and/or other information storage, transmission, reception and/or display devices. Accordingly, a computing platform refers to a system or a device that includes the ability to process and/or store data in the form of signals. Thus, a computing platform, in this context, may comprise hardware, software, firmware and/or any combination thereof. Further, unless specifically stated otherwise, a process as described herein, with reference to flow diagrams or otherwise, may also be executed and/or controlled, in whole or in part, by a computing platform.

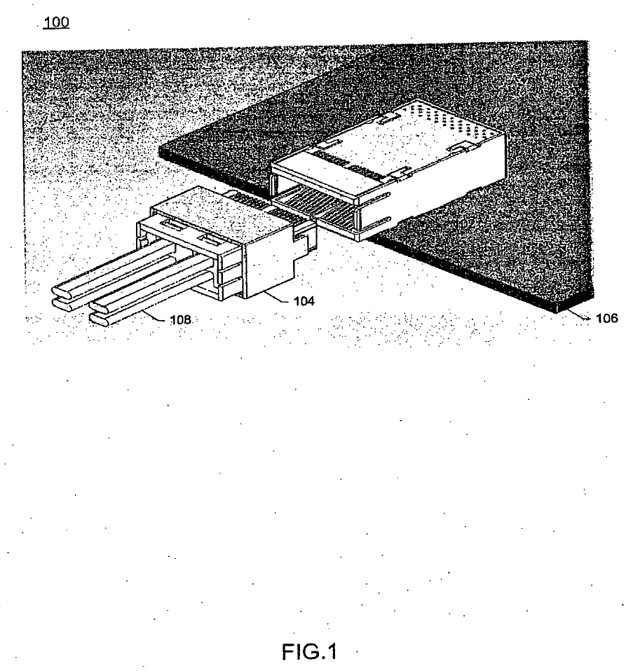

Illustrated in FIG. 1 is a perspective view of an electrical connector assembly 100. Electrical connector assembly 100 may, when implemented as part of a data transmission device such as an Ethernet compliant device, be utilized in the transmission of data in accordance with any one of a variety of data protocols. In this embodiment, electrical assembly 100 comprises a receptacle assembly 102 coupled to a substrate 106, and a plug assembly 104 coupled to communications media 108. Receptacle assembly 102 may be coupled to a substrate 106, which may comprise a printed circuit board. The circuit board may comprise a portion of a communication device such as a switch or router, for example. As will be explained in more detail later, receptacle assembly 102 may be formed from a plurality of circuit boards, which may be stacked and/or laminated, and may additionally comprise a housing that may provide particular functionality. Receptacle assembly 102 may include a plurality of metal contact arrays, which may form ports, for example. The metal contact arrays may be arranged to couple to a plug. For example, in this embodiment receptacle assembly 102 may include four metal contact arrays or ports, arranged in a 2×2 configuration, as just an example. This arrangement may be referred to as a quad receptacle, and, additionally, may be referred to as a high density receptacle, due to the particular configuration. However, here and throughout the specification, it is worthwhile to note that the claimed subject matter is not limited to the configurations as shown, but may include additional configurations. For example, receptacle assembly 102 may comprise a plurality of ports that may be arranged in any configuration that may be implemented as part of a receptacle, for example. Additionally, receptacle assembly 102 may include other features that may provide particular functions such as voltage isolation, impedance matching and noise filtering. However, these features will be explained in more detail later.

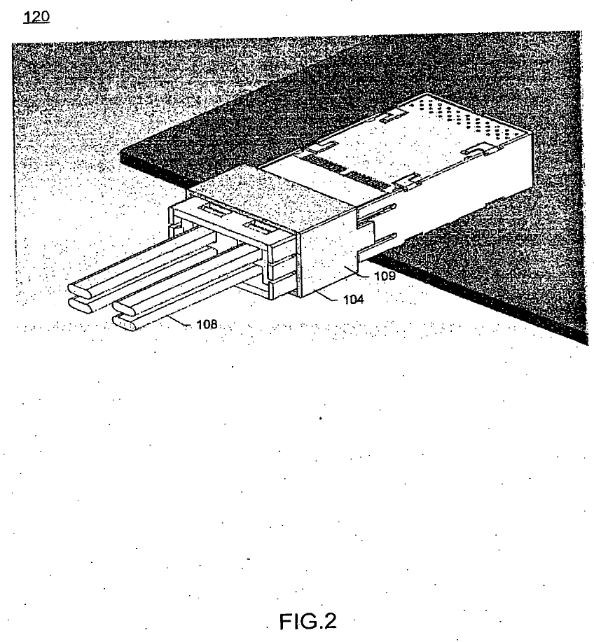

Electrical connector assembly 100 includes plug assembly 104. Plug assembly 104 may be adapted to be removably and/or permanently coupled with receptacle assembly 102, such as by use of mechanical features formed on one or both of the receptacle assembly and the plug assembly, explained in more detail later. Plug assembly 104, in this embodiment, may include an array of plugs that may be arranged in a similar manner as the receptacle ports of receptacle assembly 102. In this embodiment, plug assembly 104 may include four plugs arranged in a 2×2 manner, although, as mentioned previously the claimed subject matter is not limited in this respect. In this embodiment plug assembly 104 may be referred to as a quad plug and/or a high density plug. Plug assembly 104 may be coupled to communications media 108. Communications media 108 may include any type of media that may be suitable for use in data transmission, and may include, for example, unshielded twisted wire pair, coaxial cable, optical cable and so forth. Plug assembly 104 may be referred to as a cable termination in at least one embodiment. Additionally, the plugs of plug assembly 104 may include metal leads (not shown) adapted to contact ends of the communications media 108. When assembled into an electrical assembly as illustrated in FIG. 2, the metal contact arrays of receptacle 102 may be adapted to provide spring force to the metal contacts of plug assembly 104 to provide electrical continuity between the plug and receptacle. However, portions of the plug assembly, such as metal contact portions, will be explained in greater detail herein.

Additionally, it is worthwhile to note that embodiments of the claimed subject matter are not limited in terms of materials. For example, one or more portions of one or more components disclosed herein may be formed from materials including but not limited to plastics, synthetics, including vinyl and composites thereof, conductive materials including copper, gold, silver, platinum, tin, aluminum, palladium, nickel, and/or alloys thereof. Additionally, components may be formed by use of one or more tools and by use of one or more methods of formation, but the particular methods of formation may depend on the particular materials selected to form the components.

Referring now to FIG. 2, there is illustrated an embodiment of an electrical connector assembly 120. Electrical connector assembly 120, here, comprises receptacle assembly 102 coupled with plug assembly 104. Plug assembly 104 and receptacle assembly 102 may be coupled by use of mechanical coupling features 107 and 109. These features may comprise complimentary mechanical fastening devices such as a tab and a tab receiver, for example, and will be explained in more detail later. Mechanical coupling features such as these may cooperate to provide mechanical attachment functions, to allow the receptacle assembly 102 to be attached to plug assembly 104, and/or removed from plug assembly 104. When coupled, metal contacts of the plug assembly 104 may electrically contact metal contacts of the receptacle assembly 102, such as in an interference fit by use of spring force provided by the metal contacts of the receptacle assembly. The spring force may provide electrical interconnection between the communications media 108 and substrate 106. In this manner, electrical connector 120 may be utilized to provide interconnection between a data transmission device and a communications media, to facilitate the transmission of signals, such as Ethernet compliant data signals, for example.

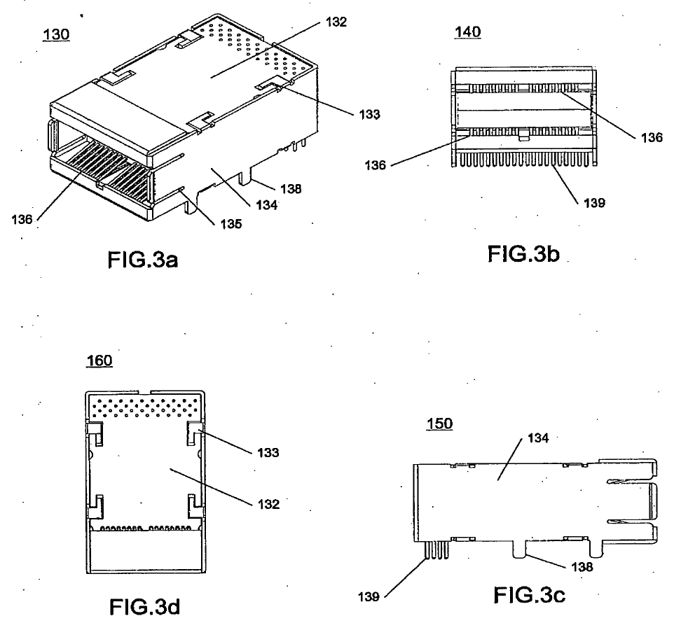

Illustrated in FIGS. 3a-3d are a perspective view 130, front view 140, side view 150 and top view 160 of a receptacle assembly. The receptacle assembly as illustrated in the various views may comprise one or more circuit boards 132, which may be stacked and/or laminated to form a top portion, and/or a bottom portion (not shown). In at least one embodiment, the receptacle assembly as illustrated may include two pairs of laminated circuit boards 132, wherein the circuit boards may include features that may be integrated with the circuit boards. However, particular features and/or functions of the circuit boards 132 will be explained in more detail later. The circuit boards 132 may additionally be at least partially coupled by use of a metal housing 134 that may form one or more walls of the receptacle assembly. Metal housing 134 may additionally have one or more housing tabs 133 formed thereon to provide attachment functions to the circuit boards 132, for example. Additionally, mounting tabs 138 may be formed as part of the metal housing 134, to provide attachment functions between the housing and a substrate (not shown). Metal housing 134 may provide shielding functions for a receptacle assembly, to provide control and/or suppression of EMI and/or radiation emissions, for example. The illustrated receptacle assembly may additionally include a plurality of metal contact arrays 136, which may include a plurality of metal contacts that may be spring loaded, and may be adapted to couple to metal contacts of one or more plugs, such as plug assembly 104 of FIG. 1.

The metal housing 134 may include one or more tabs 135. Tabs 135 may be formed from metal as part of the metal shield, and may provide mechanical connection functions, such as removable connection functions for a plug assembly. Tabs 135 may include a bump or dimple feature that may enable mechanical locking or fixing, as explained in more detail later. Although not illustrated in detail, one or more of the circuit boards 132 may include embedded magnetic, resistive and/or capacitive elements that may enable the formation of a high density receptacle, meaning, in this context that the receptacle may be capable of providing data transmission functions that may not be achievable by other receptacles that are not high density. Additionally, the circuit boards 132 may include features such as embedded circuitry and/or routing features that may allow for such a configuration. The receptacle assembly illustrated may additionally include interconnect portion 139, which may provide electrical interconnect between one or more portions of the receptacle and a substrate coupled to the receptacle. This may provide electrical connectivity between the connector arrays 136 and a substrate, which, in turn, may provide interconnectivity between a substrate and a plug that may be coupled to the receptacle assembly, for example. Additionally, the illustrated receptacle may comprise additional components that may be better understood with reference to the following figures.

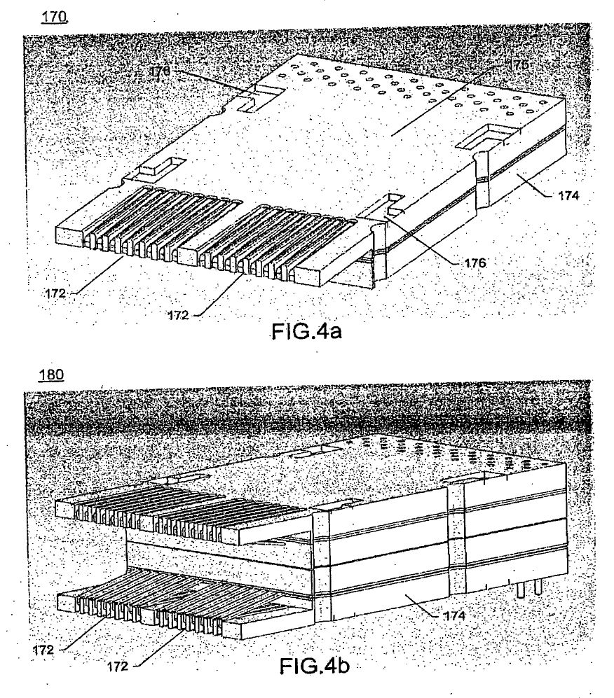

Illustrated in FIG. 4a and FIG. 4b are receptacle sub-assembly components 170 and 180. Substrate assembly 170 may include one or more substrates such as a pair of printed circuit boards 174, which may have common features and/or features that may vary, for example. In this embodiment, substrate assembly 170 comprises two substrates 174 that are coupled such as by stacking and/or laminating the substrates. The substrates 174 may be formed from one or more materials or combination of materials, such as described previously. Substrates 174 may include embedded or partially embedded circuitry (not shown) that may be adapted to perform various functions, including routing of signals, for example. Additionally, substrates 174 may include components such as magnetic, resistive and/or capacitive components that may provide additional functions as explained previously. The various components may be embedded and/or formed on the substrates such that the surface 175 of the substrates 174 may be substantially planar and/or substantially unpopulated by components such as described previously. This may provide particular functionality, including allowing stacking of a plurality of receptacle assemblies. Although the claimed subject matter is not limited to any particular configuration of the substrate components, one potential embodiment of embedded magnetic components is disclosed in U.S. patent application Ser. No. ______, filed on Sep. 22, 2005, entitled, “Magnetic Components”, by James E. Quilici. Substrates 174 may additionally have one or more patterned features 176 formed thereon. The pattemed features 176 may be adapted to receive metal tabs, such as housing tab 133 of FIG. 3a. Substrates 174 may include metal contact arrays 172, and in this embodiment includes two contact arrays. The contact arrays 172 may be adapted to provide spring force to electrically contact metal contacts of a plug, as described previously. Substrates 174 may be adapted to be formed in to an assembled substrate sub-assembly, such as assembled substrate sub-assembly 180 of FIG. 4b. Assembled substrate sub-assembly 180, in this embodiment, comprises a plurality of four substrates 174, which may be stacked and laminated as illustrated to form a substrate sub-assembly that may be suitable for use as a portion of a receptacle assembly. When assembled, substrate sub-assembly 180 includes a plurality of contact arrays arranged to form a quad receptacle having four receptacles arranged in a 2×2 manner, although the claimed subject matter is not so limited. The pairs of substrates may be coupled by laminating and/or by use of mechanical components, such as by use of metal housing 134 as shown in FIG. 3a, for example.

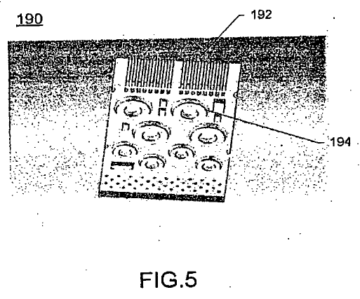

Illustrated in FIG. 5 is an underside view of a substrate 190 that may be employed as part of a receptacle assembly, such as receptacle assembly 102 of FIG. 1. Substrate 190 may comprise a printed circuit board, and may include metal contact arrays 192 formed thereon. Additionally, one or more electrical components 194 may be disposed on the substrate 190. Electrical components 194 may include, for example, magnetic elements, resistive elements, capacitive elements and/or one or more additional elements that may provide particular functions when implemented as part of a connector assembly, as explained previously. Components 194 may be disposed after formation of substrate 190 and/or may be integrated as part of substrate 190, although the claimed subject matter is not limited to any manner of forming a substrate and components, as illustrated in FIG. 5.

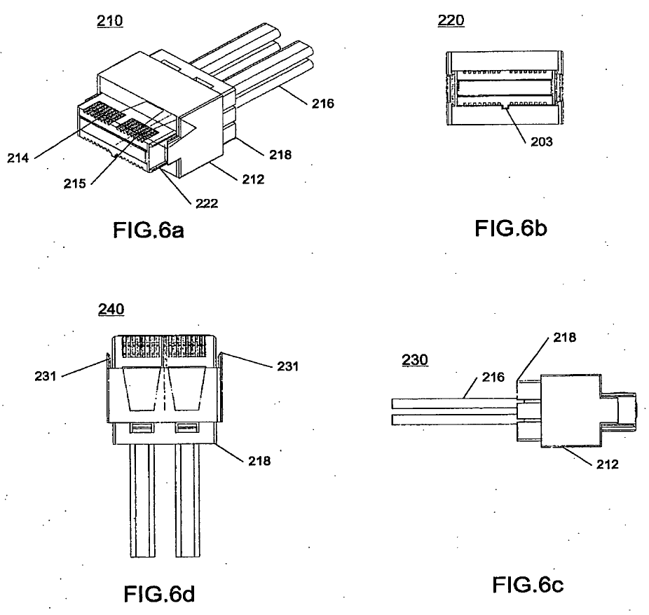

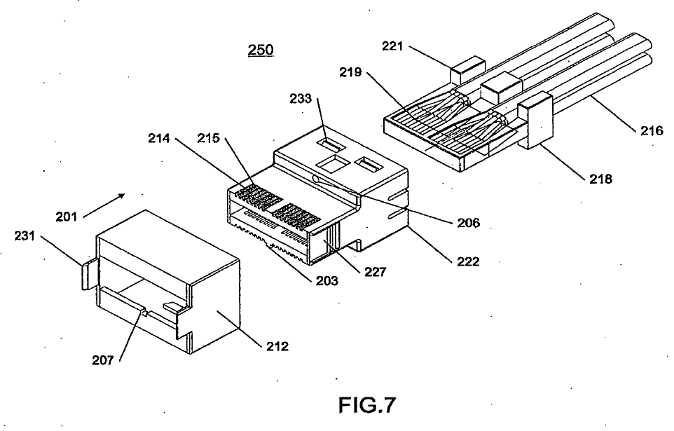

Illustrated in FIGS. 6a-6d are a perspective view 210, a front view 220, a side view 230 and a top view 240, respectively, of a plug assembly. Contact channel arrays 214 are formed on the plug shroud 222, and may be adapted to receive a plurality of metal leads 215, which may then form contact arrays, for example. One or more cable trays 218 may be coupled with communications media 216, and may be disposed at least partially in the plug shroud 222, for example. The plug shroud may include crimping tabs that may be adapted to crimp the communications media to fix the media to the shroud. The plug shroud 222 may have a notch 203 formed thereon, adapted to insert into a corresponding channel on a receptacle. The notch 203 may align the plug assembly as it is inserted in a receptacle assembly. The plug assembly includes a slip collar 212 that may be disposed over at least a portion of a plug shroud 222. The slip collar 212 is adapted to fit substantially over one or more other portions of the shroud 222, and may be adapted to move or actuate with respect to the plug shroud, such as between a first position and a second position with respect to the shroud. A compression spring (not shown) may be inserted in the plug shroud, and may apply spring force to the slip collar. This configuration may be implemented to along with extension features 231 to secure the plug assembly to a receptacle assembly, the operation of which will be explained in more detail later. Contact channels arrays 214 may have leads 215 press fit therein, and the contact channel arrays with leads 215 may form a quad plug having four connectors in a 2×2 configuration. Particular components will be explained in more detail with reference to FIGS. 7-10, below.

Illustrated in FIG. 7 is an exploded perspective view of a plug assembly 250, in accordance with at least one embodiment. Plug assembly 250, in this embodiment, comprises a slip collar 212, one or more trays such as cable tray 218 coupled to communications media 216. Cable tray 218 includes one or more wire channels 219 that may be adapted to receive one or more wires, such as from media 216. The wire channels may include apertures adapted to allow press fitting of wires such that wires that are press fitted into the channels are substantially arranged and fixed in place, for example. The wire channels may be formed to provide a particular wiring configuration or pin-out that may be in accordance with one or more data transmission protocols. Tray 218 additionally includes one or more cable channels 221 formed thereon. Cable channels 221 may be adapted to receive one or more portions of communications media 216 and substantially fix and/or align the media in place, for example. Plug shroud 222 may include crimping tabs 233. Crimping tabs 233 may be crimped against communications media 216, such as by use of a crimping tool, to substantially fix communications media in the channels 221, for example. Plug shroud 222 additionally includes contact channel arrays 214, which, in combination with metal leads 215 form contact arrays. Leads 215 may be press fitted into channels 214. When tray 218 is coupled with plug shroud 222, the leads may be forced through the wire insulation of communications media 216 to contact conductive portions of the communications media.

Shroud 222 may be adapted to receive the tray 218, and substantially fix and/or orient the tray in place, such as by use of one or more additional features not shown in detail. Plug shroud 222 includes hole feature 206. Hole feature 206 is adapted to receive a compression spring (not shown), which may be used to exert force on slip collar 212. Plug shroud 222 additionally includes one or more other features, such as notch 203 and channel feature 227. Channel feature 227 may be adapted to receive a tab having one or more attachment features such as a bump or dimple. For example, tab 135 of FIG. 3a may include a bump that may be adapted to fit in a channel of channel feature 227. Collar 212 may be disposed over a portion of shroud 222, and may contact a compression spring disposed in hole feature 206. In operation, the plug assembly may be coupled to a receptacle assembly, such as receptacle assembly 130 of FIG. 3a. In this example, prior to coupling, slip collar 222 may be slid from a first position to a second position, such as along direction 201, to expose channel feature 227. A bump formed on tab 135 of receptacle assembly 130 may be coupled to a channel of channel feature 227. Slip collar 212 may be slid along the plug shroud 222 from the second position back to the first position, such that extension feature 231 contacts tab 135. The extension feature 231 may fix tab 135 to channel feature 227, by applying force to tab 135 to substantially fix the bump of tab 135 into channel feature 227. This may result in the plug array being fixed to the receptacle array. Additionally, removal may comprising performing the reverse of one or more of the above operations. Components of plug assembly 250 will be explained in more detail hereinafter.

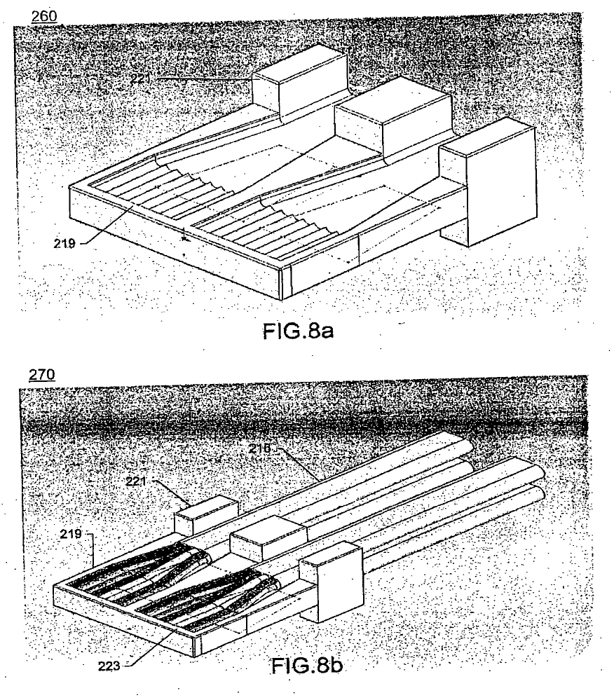

Illustrated in FIGS. 8a and 8b are an unpopulated wire tray 260 and a populated wire tray 270. Unpopulated wire tray 260, as illustrated, includes a plurality of features formed thereon, such as wire channels 219, which may be adapted to receive one or more wires. Wire channels 219 may be arranged in a particular pin-out configuration. The particular number, size and/or configuration wire channels 219 may depend at least in part on the particular communications media being employed as part of a plug assembly and/or may depend at least in part on the particular plug assembly being formed. In this embodiment, the wire tray 260 includes two arrays of eight wire channels. The wire channels may be formed such that wires may be press fit into the channels, for example. Wire tray 260 may additionally include cable channels 221. Cable channels 221 may provide particular functionality, such as providing fixing and/or locking functions for a cable. Turning now to populated wire tray 270 of FIG. 8b, wire channels 219 are populated by a plurality of wires 223. Wires 223 may comprise wires of a communications media 216, for example, and, in this embodiment, communications media 216 includes eight wires. Wires 223 may be insulated wires, for example, and may be pressed into the formed channels 219 of the wire tray 270. The communications media 216 may additionally be pressed or otherwise coupled to the wire tray by use of channels 221, and/or by use of crimping tabs 233 of FIG. 7. The formed wire channels 219 and/or one or more of the above described features may substantially fix and/or hold the communications media 216 and/or one or more wires 223 substantially in place.

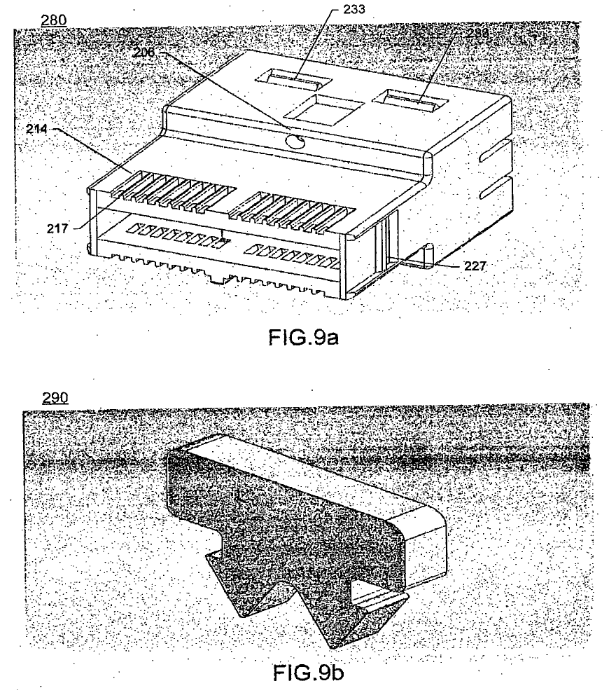

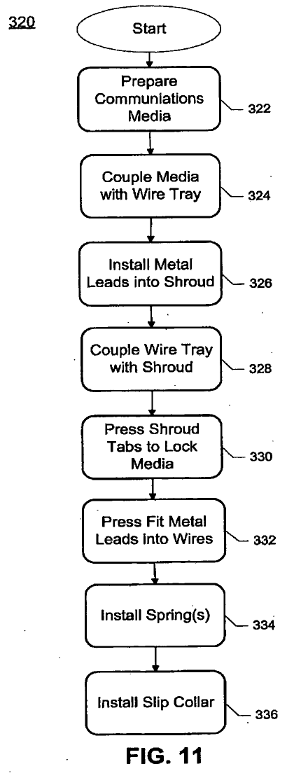

Referring now to FIG. 9a, there is illustrated a wire shroud 280 having one or more features formed thereon. Wire shroud 280 may include crimping tabs 233, which may provide mechanical locking of the communications media. Additionally, wire shroud 280 may include one or more features that may enable a collar to be substantially fixed to the wire shroud, such as collar 212 of FIG. 7. These features may include a hole feature 206 adapted to receive a compression spring, one or more features such as snap features not shown in detail, and/or channel feature 227, which may cooperate with features on a slip collar and a tab of a receptacle to fix the plug assembly to the receptacle. Wire shroud 280 may additionally include a plurality of contact channels arrays 214, such as a quad arrangement of contact channels, as explained previously. The contact channels arrays 214 may be adapted to receive one or more leads, but as shown are unpopulated. Illustrated in FIG. 9b is a metal lead 290. Lead 290 may a conductive lead. Lead 290 may be adapted to be inserted at least partially in one or more channels of array 214, for example. Additionally, leads 215 may be adapted to contact a conductive portion of one or more wires of a communications media, such as one or more wires 219 of communications media 216 of FIG. 7, for example. Utilization of leads 290 may be better understood with reference to FIG. 11.

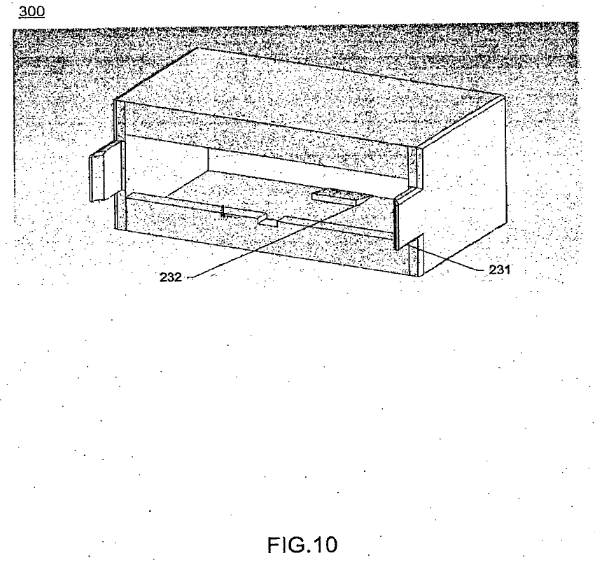

Illustrated in FIG. 10, there is illustrated a slip collar 300. Slip collar 300 may be adapted to fit over a portion of wire shroud 222 of FIG. 7. Slip collar 300 may include extension features 231, which may be adapted to cooperate with channel features of the wire shroud to lock a tab of a receptacle to the channel by pressing the tab into the channel. Slip collar 300 may additionally include snapping feature 232, which may be adapted to provide coupling functions, such that a collar may be mechanically fixed to a shroud, yet be capable of sliding between a first and a second position along the shroud body for example. In operation, a compression spring may apply force to the slip collar to force the collar in a first position with respect to the shroud, and a user may apply force to the collar to force the collar to a second position with respect to the shroud. Forcing the slip collar to a second position may allow the exposing of channel features of a wire shroud, and may additionally allow the release of tabs of a receptacle from a channel feature of the shroud, which may additionally allow removal of a plug assembly from a receptacle assembly.

FIG. 11 is a flow diagram, according to one embodiment, of a process 320 of forming an electrical connector assembly. However, for flow diagrams presented herein, the order in which the blocks are presented does not necessarily limit claimed subject matter to any particular order. Additionally, intervening blocks not shown may be employed without departing from the scope of claimed subject matter. Flow diagrams depicted herein may, in alternative embodiments, be implemented in a combination of hardware, software and/or firmware, such as part of a computer system. The functionality of flow diagram 320 may be executed manually, such as by a user, and/or may be executed by a computing system adapted to operate one or more formation tools, as just an example.

At block 322, a communications media may be prepared to be utilized as part of a plug assembly. A communications media may comprise a cable, having a plurality of wires, such as unshielded twisted pair wiring, for example. Preparation of the cable may comprise removing cable insulation to a specified distance and/or separating or spreading the wires, for example. At block 324, the communications media may be coupled with a wire tray, such as wire tray 260 of FIG. 8a. One. or more wires of the communications media may be coupled to one or more wire channels, such as wire channels 219. The wires may be press fitted into the channels and/or may be coupled by other suitable methods. Additionally, the communications media may be crimped to the wire tray by use of one or more crimping tabs formed on the plug assembly.

At block 326, metal leads may be installed in a shroud, such as shroud 280 of FIG. 9a. The metal leads may comprise leads 215 as illustrated in FIG. 9b. The metal leads may be installed in metal contact channels formed in the shroud. At block 328, the wire tray populated with one or more wires of a communications media may be coupled to the shroud. The wire tray may be coupled to the shroud by use of features formed on one or both of the wire tray and/or the shroud. For example, at block 330 one or more crimping tabs formed on the shroud may be crimped to lock the media.

At block 332, the one or more metal leads installed at block 326 may be pressed at least partially into the wires in the vicinity of the wire channels, for example. This may result in the leads contacting conductive portions of the wires, such as by being pressed through insulation of the wires and in contact with conductive portions of the wires. Pressing may be performed by one or more tools and/or fixtures that may be specially adapted for this function, although not illustrated in detail. At block 334, one or more springs may be installed in features formed on the shroud. For example, a spring may be installed in a hole feature, such as hole feature 206 of FIG. 9a. At block 336, a slip collar may be coupled to the shroud. The slip collar may be installed over at least a portion of the shroud, and may be locked to the shroud by use of one or more features formed on the slip collar and/or the shroud. After locking the slip collar to the shroud, a plug assembly such as plug assembly 210 of FIG. 6a may be substantially formed. The plug assembly may include features that may cooperate to lock the plug assembly to a receptacle assembly, and may additionally allow ease of removal of the plug assembly by sliding a slip collar from a first position to a second position.

In the preceding description, various aspects of claimed subject matter have been described. For purposes of explanation, systems and configurations were set forth to provide a thorough understanding of claimed subject matter. However, it should be apparent to one skilled in the art having the benefit of this disclosure that claimed subject matter may be practiced without the specific details. In other instances, well-known features were omitted and/or simplified so as not to obscure claimed subject matter. While certain features have been illustrated and/or described herein, many modifications, substitutions, changes and/or equivalents will now occur to those skilled in the art. It is, therefore, to be understood that the appended claims are intended to cover all such modifications and/or changes as fall within the true spirit of claimed subject matter.

1. An electrical connector assembly, comprising:
a receptacle assembly having a plurality of receptacles, wherein at least a portion of the receptacle assembly is shielded;
a plug assembly having a plurality of plugs adapted to contact at least a portion of the receptacles, wherein the plug assembly includes a plurality of wire trays coupled to a shroud.

2. The electrical connector assembly of claim 1, and further comprising a slip collar coupled to the plug assembly, wherein the slip collar is configured to actuate between a first and a second position with respect to the shroud.

3. The electrical connector of claim 2, and further comprising:
one or more tabs formed on the receptacle assembly; and
one or more channel features formed on the plug assembly, wherein the one or more tabs are coupled with the one or more channel features.

4. The electrical connector of claim 3, wherein the slip collar is configured to contact the receptacle assembly tabs and apply force to the one or more tabs when the slip collar is in a first position.

5. The electrical connector assembly of claim 1, and further comprising communications media coupled to the wire tray.

6. The electrical connector assembly of claim 1, wherein the receptacle assembly comprises four receptacles arranged in a 2×2 configuration.

7. The electrical connector assembly of claim 1, wherein the plug assembly comprises four plugs arranged in a 2×2 configuration.

8. The electrical connector assembly of claim 1, wherein the connector assembly is coupled to a circuit board of a data transmission device.

9. The electrical connector assembly of claim 5, wherein the communications media comprises unshielded twisted pair wire.

10. The electrical connector of claim 2, and further comprising a compression spring coupled to the shroud, and configured to apply spring force to the slip collar.

11. An apparatus, comprising:
a plug assembly, comprising:
a wire tray having a plurality of features adapted to substantially fix a plurality of wires in a pin-out configuration;
a shroud coupled to the wire tray, wherein the shroud includes a plurality of plugs adapted to contact at least a portion of the receptacles, and at least one channel feature adapted to receive a portion of one or more tabs of a receptacle assembly; and
a slip collar coupled to the shroud, and adapted to be actuated between a first to a second position with respect to the shroud.

12. The apparatus of claim 11, wherein the slip collar is capable of applying force to one or more tabs of a receptacle assembly when the one or more tabs are coupled to the at least one channel feature.

13. The apparatus of claim 11, and further comprising a compression spring coupled to the shroud, and configured to apply spring force to the slip collar.

14. The apparatus of claim 11, wherein the plurality of plugs comprise four plugs arranged in a 2×2 configuration.

15. The apparatus of claim, wherein the shroud further comprises a plurality of crimping tabs adapted to crimp communications media.

16. The apparatus of claim 15, and further comprising communications media coupled to the wire tray by use of the plurality of crimping tabs.

17. The apparatus of claim 16, wherein the communications media comprises unshielded twisted pair wire.

18. The apparatus of claim 8, wherein the plurality of plugs of the shroud comprise a plurality of contact arrays arranged in a pin-out configuration in accordance with a data transmission protocol.

19. The apparatus of claim 18, wherein the data transmission protocol comprises the Ethernet protocol.

20. The apparatus of claim 18, wherein the contact arrays further include one or more leads press fitted into the one or more channels.

21. An apparatus, comprising:
a receptacle assembly, comprising:
a plurality of circuit boards having a plurality of contact arrays formed thereon, wherein at least a portion of the circuit boards are stacked;
a metal housing formed over at least a portion of the stacked circuit boards, wherein the plurality of circuit boards and the metal housing form a plurality of receptacles.

22. The apparatus of claim 21, wherein the plurality of receptacles comprise four receptacles arranged in a 2×2 configuration.

23. The apparatus of claim 21, and further comprising one or more tabs formed on the metal housing and adapted to couple to one or more channel features of a plug assembly.

24. The apparatus of claim 21, wherein at least a portion of the receptacles are capable of coupling to one or more types of communications media, including: unshielded twisted pair wire and/or coaxial cable.

25. The apparatus of claim 21, and further comprising a data transmission device.

26. The apparatus of claim 21, and further comprising four circuit boards, wherein the four circuit boards are stacked.

27. The apparatus of claim 26, wherein at least a portion of the circuit boards comprise embedded circuitry.

28. The apparatus of claim 26, wherein at least a portion of the circuit boards have a substantially planar top surface, and comprise embedded magnetic, resistive and/or capacitive components.

29. The apparatus of claim 21, wherein the metal housing comprises an EMI shield.

30. A method, comprising:
disposing a communications media in a wire tray, wherein the communications media includes a conductive portion;
disposing the wire tray at least partially in a shroud, wherein the shroud includes one or more metal contacts; and
applying pressure to one or more metal contacts of the shroud to contact a conductive portion of the communications media.

31. The method of claim 30, and further comprising crimping one or more crimping tabs of the shroud to crimp the communications media.

32. The method of claim 30, and further comprising:
disposing a compression spring in the shroud; and
disposing a slip collar to on the shroud, wherein the slip collar is in contact with the compression spring.

33. The method of claim 31, wherein the wire tray is substantially fixed in the shroud by use of the crimping tabs.

34. The method of claim 30, wherein the wires are arranged in a pin-out configuration.

35. The method of claim 30, wherein applying pressure comprises press fitting the metal contacts into at least a portion of the communications media to form electrical continuity between the metal contacts and the communications media.
